(19) United States
(12) Patent Application Publication
(10) Pub. No.: US 2007/0065325 A1
(43) Pub. Date: Mar. 22, 2007

(54) Scroll compressor

(75) Inventors: Makoto Takeuchi, Aichi (JP); Tetsuzo Ukai, Aichi (JP); Masaaki Tokuda, Aichi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MITSUBISHI HEAVY INDUSTRIES, LTD., Tokyo (JP)

(21) Appl. No.: 11/602,965

(22) Filed: Nov. 22, 2006

Related U.S. Application Data
(62) Division of application No. 10/914,644, filed on Aug. 10, 2004.

(30) Foreign Application Priority Data
Aug. 11, 2003 (JP) 2003-291296
Aug. 11, 2003 (JP) 2003-291297

(51) Int. Cl. F01C 1/02; F01C 1/063; F04C 2/00; F03C 2/00; F04C 18/00

(52) U.S. Cl. 418/55.1; 418/55.5

(57) ABSTRACT

A scroll compressor includes a first scroll and a second scroll. The first scroll has a step portion that separates an elevated portion and a recessed portion of a surface of the first scroll. A spiral wall of the second scroll has a step that separates an elevated portion and a recessed portion of the wall. A first bypass hole is provided in the elevated portion of the surface of the first scroll. A second bypass hole is provided in the recessed portion of the surface of the first scroll. The second bypass hole is within 360 degrees toward a center of the spiral of the first scroll from an outer end of the spiral. The first bypass hole is within 360 degrees from the second bypass hole toward the center of the spiral.

This application is a divisional of application Ser. No. 10/914,644, filed Aug. 10, 2004.

### BACKGROUND OF THE INVENTION

1) Field of the Invention

The present invention relates to a scroll compressor in an air conditioning apparatus, a refrigerating apparatus, and the like.

2) Description of the Related Art

A scroll compressor includes a fixed scroll and a revolving scroll. The fixed scroll includes a spiral wall that is vertically fixed to an end plate. The revolving scroll also includes a spiral wall, which has substantially the same shape as the wall of the fixed scroll, that is vertically fixed to another end plate. The scroll compressor is assembled in such a manner that the walls of the fixed scroll and the revolving scroll engage with each other. In this state, the revolving scroll is revolved with respect to the fixed scroll, whereby a volume of a compression chamber formed between the walls is gradually reduced to compress fluid in the compression chamber.

Some conventional scroll compressors are provided with a step portion between the spiral walls. The step portion is formed with surfaces at different levels. The surface that is closer to an inner end of the spiral (closer to a center of the spiral) is more distant from a surface of the end plate than the surface that is closer to an outer end of the spiral (closer to a fluid drawing port). An edge of the wall is formed in a shape engaging with a corresponding step portion. With such a structure, a fluid drawing capacity of a chamber on the outer end side of the spiral is increased, and pressure in a chamber on the inner end side is increased. Thus, an improved compression ratio is obtained without increasing an outer diameter of a scroll (e.g., Japanese Patent Publication No. S60-17956).

In other conventional scroll compressors, a fluid through hole (bypass hole) is provided in an end plate in a portion between a spiral wall of a fixed scroll. The fluid through hole is openable and closable. With this structure, by opening the fluid through hole as required, a compression volume in a compression chamber is reduced to lower a load on a drive source (e.g., Japanese Patent Publication No. H1-33675).

However, when the bypass hole is provided in a portion that is closer to the outer end of the spiral than the step portion, there is a problem in that a compression loss occurs due to leakage of fluid from an engaging part of the step portion and the wall. On the other hand, when the bypass hole is provided in a portion that is closer to the center of the spiral than the step portion, since compression is performed on the outer end side of the spiral, there is a problem in that excessive compression occurs before reducing a compression volume with the bypass hole. A load is applied to a drive source in an area where the excessive compression occurs.

### SUMMARY OF THE INVENTION

It is an object of the present invention to provide a scroll compressor that makes it possible to reduce the compression loss.

A scroll compressor according to an aspect of the present invention includes a first scroll that includes a first plate having a surface and a first wall fixed in a spiral manner on the surface of the first plate; a second scroll that includes a second plate having a surface and a second wall fixed in a spiral manner on the surface of the second plate, wherein the first wall of the first scroll and the second wall of the second scroll engage with each other thereby forming a plurality of compression chambers, and the first scroll and the second scroll rotate relative to each other; the surface of the first plate having a first bottom portion and a second bottom portion and the first bottom portion and the second bottom portion are separated by a first bottom step, wherein the first bottom portion is positioned inside a first spiral formed by the first wall and near a center of the first spiral, the first bottom portion is elevated in a direction of height of the first wall, the second bottom portion is positioned inside the first spiral and on an outer end of the first spiral, and the second bottom portion is recessed in the direction of the height of the first wall; the second wall of the second scroll having a first wall portion and a second wall portion and the first wall portion and the second wall portion are separated by a first wall step, wherein the first wall portion is positioned on a free end of the second wall and near a center of a second spiral formed by the second wall, the first wall portion is recessed in a direction of height of the second wall, the second wall portion is positioned on the free end of the second wall and on an outer end of the second spiral, and the second wall portion is elevated in the direction of the height of the second wall, and at one particular point the first bottom step abutting with the first wall step when the first scroll and the second scroll rotate relative to each other; and a bypass hole in the first bottom portion and that lets a compression chamber among the compression chambers to communicate with outside.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a sectional view of a scroll compressor in a first embodiment according to the present invention;

FIG. 2 is a perspective view of a fixed scroll and a revolving scroll in the first embodiment;

FIG. 3 is a sectional view of the fixed scroll (or the revolving scroll) in the first embodiment;

FIG. 4 is a plan view of the fixed scroll in the first embodiment;

FIGS. 5 to 9 are schematics for explaining an operation of the scroll compressor of the first embodiment;

FIG. 10 is a plan view of a conventional scroll compressor corresponding to the scroll compressor of the first embodiment;

FIG. 11 is a sectional view of a scroll compressor in a second embodiment according to the present invention;

FIG. 12 is a perspective view showing a fixed scroll and a revolving scroll in the second embodiment;

FIG. 13 is a sectional view of the fixed scroll (or the revolving scroll) in the second embodiment;

FIG. 14 is a plan view of the fixed scroll in the second embodiment;

FIGS. 15 to 20 are schematics for explaining an operation of the scroll compressor of the second embodiment;

FIG. 21 is a plan view of a conventional scroll compressor corresponding to the scroll compressor of the second embodiment;

FIG. 22 is a PV graph of the scroll compressor in the second embodiment; and

FIG. 23 is a PV graph of the conventional scroll compressor shown in FIG. 21.

### DETAILED DESCRIPTION

Exemplary embodiments of a scroll compressor according to the present invention will be hereinafter explained with reference to the accompanying drawings.

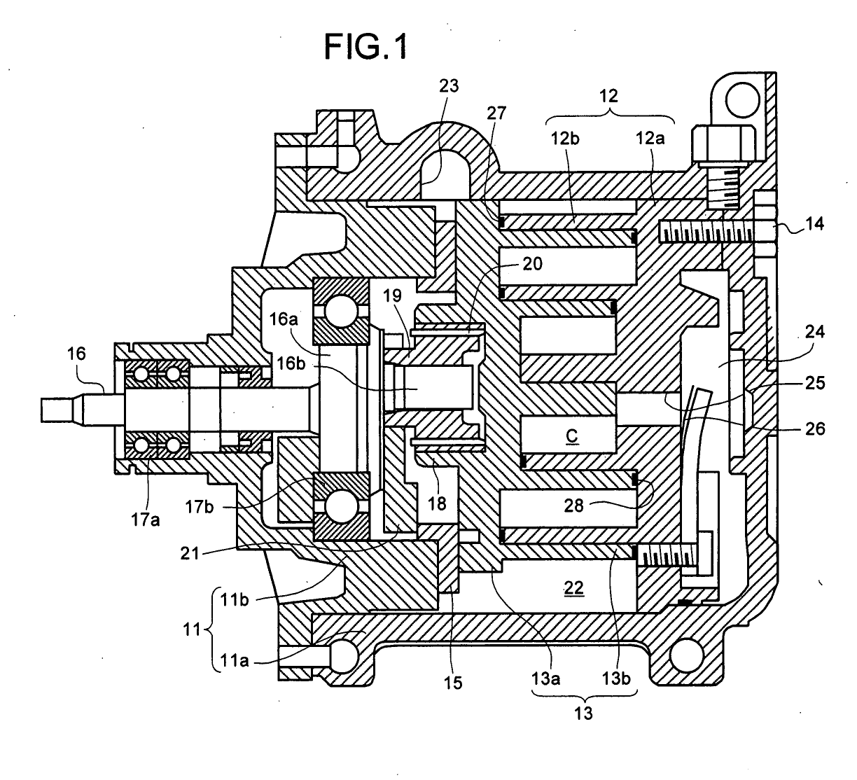

FIG. 1 is a sectional view of a scroll compressor according to a first embodiment of the present invention. This scroll compressor is provided with a scroll compression mechanism that includes a fixed scroll 12 that serves as a first scroll, and a revolving scroll 13 that serves as a second scroll. The fixed scroll 12 and the revolving scroll 13 are housed in a housing 11.

The housing 11 includes a housing body 11a that is formed in a cup shape, which has an opening, and a lid plate 11b that is fixed to the housing body 11a at the opening.

The fixed scroll 12 includes a spiral wall 12b on a surface of an end plate 12a. The spiral wall 12a is arranged vertically to the end plate 12a. The revolving scroll 13 has substantially a same structure as the fixed scroll 12, and includes a spiral wall 13b on a surface of an end plate 13a. The spiral wall 13a is arranged vertically to the end plate 13a. The wall 12b and the wall 13b are formed in substantially an identical shape.

The fixed scroll 12 is fastened to a bottom inside the cup shape of the housing body 11a with a bolt 14. The revolving scroll 13 is eccentric by a revolution radius and phase-shifted by 180 degrees with respect to the fixed scroll 12, and is combined with the fixed scroll 12 with the wall 13b thereof engaged with the wall 12b of the fixed scroll 12. Further, the revolving scroll 13 is supported to be capable of revolving, but not to be capable of rotating. A rotation preventing mechanism 15 that is provided between the lid plate 11b and the end plate 13a prevents the revolving scroll 13 from rotating.

Concerning the revolution of the revolving scroll 13, a rotation shaft 16 with a crank 16a is pierced through the lid plate 11b. This rotation shaft 16 is rotatably supported on the lid plate 11b via bearings 17a and 17b. A boss 18 is protrudingly provided in the center of the end plate 13a on a surface that is on an opposite side to the surface on which the wall 13b is arranged. An eccentric portion 16b of the crank 16a is rotatably housed in the boss 18 via a bearing 19 and a drive bush 20. Consequently, the revolving scroll 13 revolves according to the rotation of the rotation shaft 16. A balance weight 21, which cancels an unbalance amount given to the revolving scroll 13, is attached to the rotation shaft 16.

An intake chamber 22 is formed in a position around the fixed scroll 12 inside the housing body 11a. With respect to this intake chamber 22, an intake port 23, which guides low-pressure fluid toward the intake chamber 22, is provided in the housing body 11a. A discharge cavity 24 is arranged inside the housing body 11a. The discharge cavity 24 is sectioned by an inner surface at the bottom of the cup-shaped body of the housing body 11a and a surface of the end plate 12a that is on the opposite side to the surface on which the wall 12 b is arranged. With respect to this discharge cavity 24, a discharge port 25, which guides high-pressure fluid toward the discharge cavity 24, is arranged at the center of the end plate 12a on the surface on which the fixed scroll 12 is arranged. This discharge port 25 is provided in communication with a compression chamber C, which moves to the center of the spirals of the walls 12b and 13b while gradually reducing a volume thereof, in the scroll compression mechanism consisting of the fixed scroll 12 and the revolving scroll 13. A discharge valve 26, which opens the discharge port 25 only when a predetermined or higher pressure acts thereon, is provided in the center of the end plate 12a on the surface that sections the discharge cavity 24.

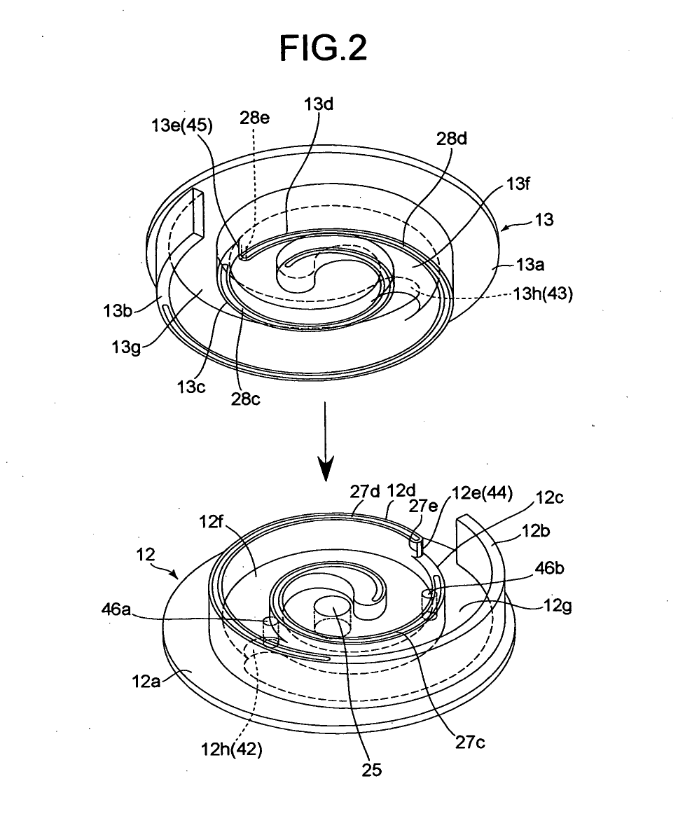

As shown in FIG. 2, the end plate 12a of the fixed scroll 12 includes a step portion 42. At this step portion 42, the surface of the end plate 12a that is toward the center of the spiral, which is formed by the wall 12b, is elevated than the surface of the end plate 12a that is toward the outer end of the spiral. Similarly, the end plate 13a of the revolving scroll 13 includes a step portion 43. At this step portion 43, the surface of the end plate 13a that is toward the center of the spiral, which is formed by the wall 13b, is elevated than the surface of the end plate 13a that is toward the outer end of the spiral. The step portions 42 and 43 are provided at positions that are substantially equidistance from the centers of the respective spirals.

Since the step portion 42 is formed on the surface of the end plate 12a, the flow path formed in the wall 12b can be divided into two portions, that is, a flow path having a shallower bottom surface 12f, which is closer to the center of the spiral, and a flow path having a deeper bottom surface 12g, which is closer to the outer end of the spiral. A coupling wall surface 12h, which is formed in the step portion 42 and stands vertically to the bottom surfaces 12f and 12g, is present between the adjacent bottom surfaces 12f and 12g. Similarly, since the step portion 43 is formed on the surface of the end plate 13a, a spiral flow path formed in the wall 13b is divided into two portions, that is, a shallow bottom surface 13f provided closer to the center and a deep bottom surface 13g provided closer to the outer end. A coupling wall surface 13h, which forms the step portion 43 and stands vertically connecting the bottom surfaces 13f ad 13g, is present between the adjacent bottom surfaces 13f and 13g.

In addition, the wall 12b of the fixed scroll 12 includes a stepped portion 44 that corresponds to the step portion 43 of the revolving scroll 13. The wall 12b includes two portions of which edge is arranged at each different level. The edge of the portion that is closer to the center of the spiral is at a lower level than the edge of the portion that is closer to the outer end of the spiral relative to the level of the surface of the end plate 12a. Similarly, the wall 13b of the revolving scroll 13 includes a stepped portion 45 that corresponds to the step portion 42 of the fixed scroll 12. The wall 13b includes two portions of which edge is arranged at each different level. The edge of the portion that is closer to the center of the spiral is at a lower level than the edge of the portion that is closer to the outer end of the spiral relative to the level of the surface of the end plate 13a.

Since the stepped portion 44 is formed, the edge of the wall 12b is divided into two portions, that is, a low edge 12c provided closer to the center and a high edge 12d provided closer to the outer end. A coupling edge 12e, which forms the stepped portion 44 and connects the edges 12c and 12d to be vertical to a revolving surface, is present between the adjacent edges 12c and 12d. Similarly, since the stepped portion 45 is formed, the edge of the wall 13b is divided into two portions, that is, a low edge 13c provided closer to the center and a high edge 13d provided closer to the outer end. A coupling edge 13e, which forms the stepped portion 45 and connects the edges 13c and 13d to be vertical to the revolving surface, is present between the adjacent edges 13c and 13d.

The coupling edge 12e is formed in such a manner that a surface of the coupling edge 12e that is vertical to the end plate 12a continues smoothly curving between the wall 12b. A curved line formed with the surface is semicircle when viewed from a direction perpendicular to the end plate 12a. A diameter of the semicircle equals to a thickness of the wall 12b. Similarly, the coupling edge 13e is formed in such a manner that a surface of the coupling edge 13e that is vertical to the end plate 13a continues smoothly curving between the wall 13b. A curved line formed with the surface is semicircle when viewed from a direction perpendicular to the end plate 13a. In addition, the coupling wall surface 12h forms an arc that is identical with an envelope drawn by the coupling edge 13e in accordance with revolution of the revolving scroll 13 when the end plate 12a is viewed from a revolving shaft direction. Similarly, the coupling wall surface 13h forms an arc that is identical with an envelope drawn by the coupling edge 12e in accordance with revolution of the revolving scroll 13.

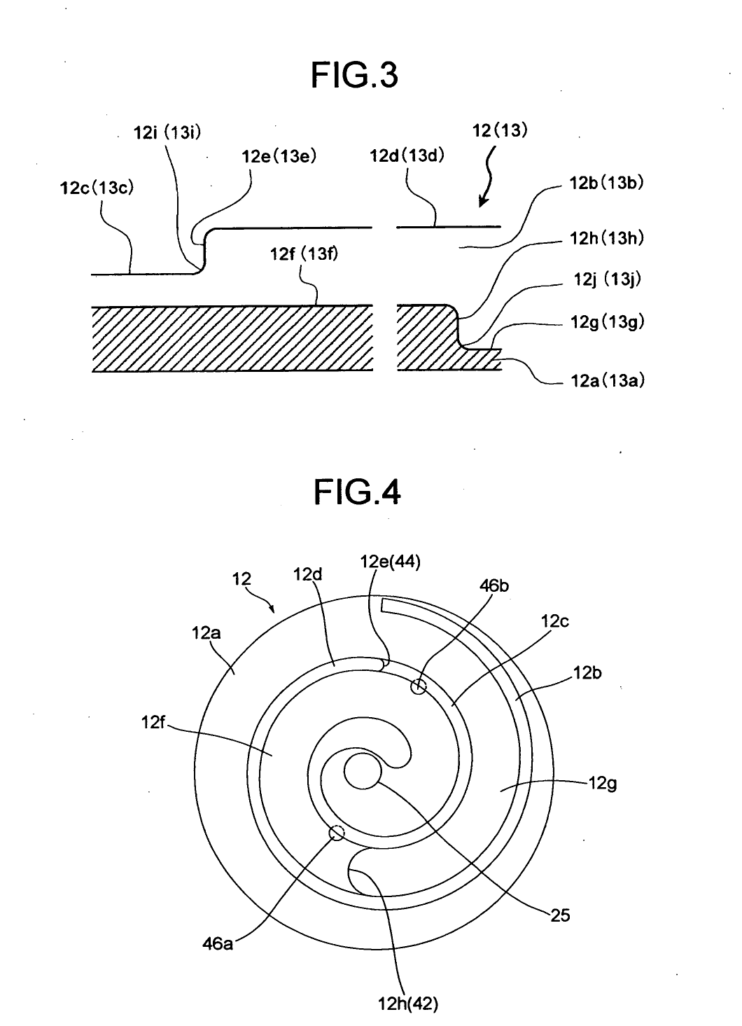

As shown in FIG. 3, a rib 12i is provided in a part where the edge 12c and the coupling edge 12e meet in the wall 12b as if the rib 12i is built up. The rib 12i is formed integrally with the wall 12b forming a recessed curved surface that continues smoothly to the edge 12d and the coupling edge 12e to avoid concentration of stresses. For the same reason, a rib 13i that has a same shape as the rib 12i is provided in a part where the edge 13c and the coupling edge 13e meet in the wall 13b.

A rib 12j is provided in a part where the bottom surface 12g and the coupling wall surface 12h meet in the end plate 12a as if the rib 12j is built up. The rib 12j is formed integrally with the wall 12b forming a recessed curved surface that continues smoothly to the bottom surface 12g and the coupling wall surface 12h to avoid concentration of stresses. Due to the same reason, a rib 13j of the same shape is provided in a part where the bottom surface 13g and the coupling wall surface 13h meet in the end plate 13a.

A part where the edges 12d and 12e meet in the wall 12b is chamfered to avoid interference with the rib 13j at the time of assembling. A part where the edges 13d and 13e meet in the wall 13b is chamfered to avoid interference with the rib 12j at the time of assembling.

As shown in FIG. 2, chip seals 27c, 27d, and 27e are disposed in the edges 12c and 12d and the coupling edge 12e of the wall 12b, respectively. Similarly, chip seals 28c, 28d, and 28e are disposed in the edges 13c and 13d and the coupling edge 13e of the wall 13, respectively.

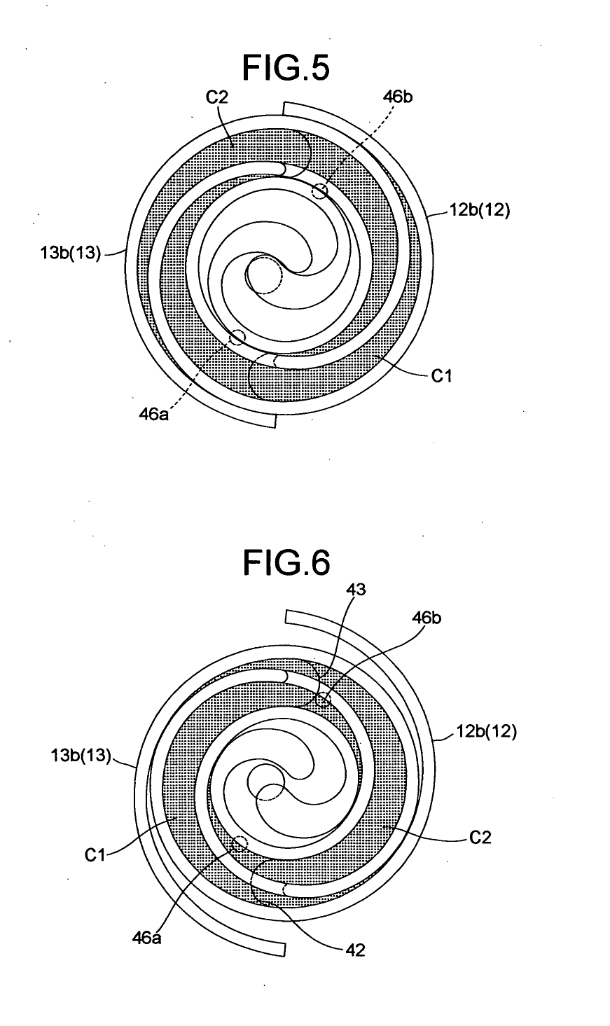

On the other hand, as shown in FIGS. 2 and 4, bypass holes 46a and 46b that pair off with each other are provided on a bottom surface 12f. The bottom surface 12f is a surface of a portion in the end plate 12a of the fixed scroll 12 that is positioned closer to the center of the spiral than the position of the step portion 42. The bypass hole 46a is arranged on the bottom surface 12f at a position near the outer end of the spiral, and is arranged along the surface of the wall 12b that faces opposite to the center of the spiral. The bypass hole 46b is in a symmetrical position with respect to the bypass hole 46a and is arranged on the bottom surface 12f in a position near the center of the spiral, and is arranged along the surface of the wall 12b that faces toward the center of the spiral.

In a state in which the revolving scroll 13 is combined with the fixed scroll 12, openings of the bypass holes 46a and 46b facing the end plate 12a are made openable and closable by the low edge 13c of the wall 13b of the revolving scroll 13. In addition, the bypass holes 46a and 46b are pierced through the end plate 12a and open at the surface opposite to the surface on which the wall 12b is arranged. Although not clearly shown in the figures, opening of the bypass holes 46a and 46b communicate with the intake chamber 22. For example, a part of the housing body 11a, where the opening of the bypass holes 46a and 46b are located, is divided from the discharge cavity 24 by a partition wall or the like and communicates with the intake chamber 22. In addition, although not clearly shown in the figures, valves are provided at the opening of the bypass holes 46a and 46b. The valves open and close the opening as required.

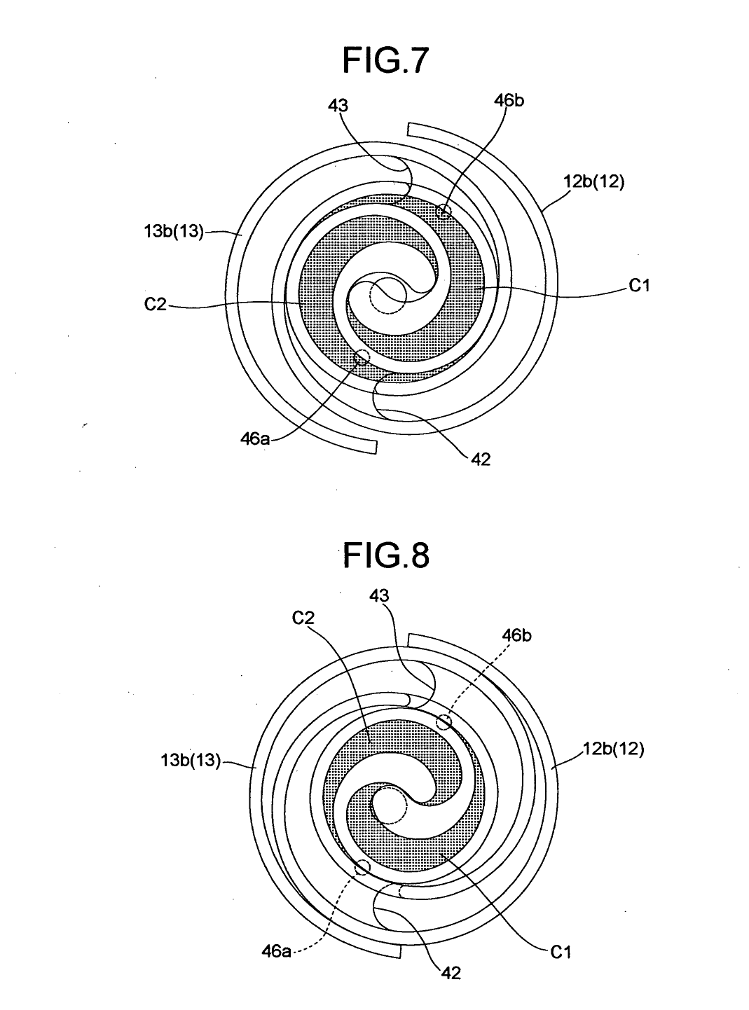

As shown in FIG. 5, when the revolving scroll 13 is combined with the fixed scroll 12, the low edge 13d comes into abutment against the shallow bottom surface 12f, and the high edge 13c comes into abutment against the deep bottom surface 12g. At the same time, the low edge 12d comes into abutment against the shallow bottom surface 13f, and the high edge 12c comes into abutment against the deep bottom surface 13g. Consequently, a pair of compression chambers C1 and C2, which are sectioned by the end plates 12a and 13a and the walls 12b and 13b opposed to each other, respectively, are formed between both the scrolls. In these compression chambers C1 and C2, since the deep bottom surfaces 12g and 13g face each other on the side closer to the outer end of the spiral than the step portions 42 and 43, the wide compression chambers C1 and C2 are obtained on the side. Since the shallow bottom surfaces 12f and 13f face each other on side closer to the center of the spiral than the step portions 42 and 43, the narrow compression chambers C1 and C2 are obtained on the side closer to the center of the spiral than the step portions 42 and 43. As a result, compression with a volume gradually reduced from the compression chambers C1 and C2 formed wide to the compression chambers C1 and C2 formed narrow is performed in the middle of movement of the compression chambers C1 and C2 from the outer end to the center in accordance with revolution of the revolving scroll 13. Thus, a compression ratio can be improved.

In the middle of movement of the compression chambers C1 and C2 from the outer end to the center in accordance with the revolution of the revolving scroll 13, when the edge 13c of the wall 13b comes off the opening of each of the bypass holes 46a and 46b facing toward the end plate 13a, and the valve at the opening of each of the bypass holes 46a and 46b that opens at the other side of the end plate 12a is opened, the bypass holes 46a and 46b cause the compression chambers C1 and C2 and the intake chamber 22 to communicate with each other. In addition, the bypass holes 46a and 46b separate the compression chambers C1 and C2 and the intake chamber 22 when the valve is closed. As a result, if the valves are opened as required, since compression is not performed in the compression chambers C1 and C2 of which compression is released through the opening of the bypass holes 46a and 46b, it becomes possible to reduce a compression volume to reduce load on the drive source driving the rotation shaft 16. In this way, the bypass holes 46a and 46b performs volume control for the compression chambers C1 and C2.

How the scroll compressor the compresses a fluid will be explained with reference to FIGS. 5 to 9. Note that, in the following explanation, the valves are performing an opening operation in the opening of the bypass holes 46a and 46b.

In the state shown in FIG. 5, the outer end of the wall 12b comes into abutment against the surface of the wall 13b that faces opposite to the center of the spiral, and the outer end of the wall 13b comes into abutment against the surface of the wall 12b that face opposite to the center of the spiral. Fluid is encapsulated between the end plates 12a and 13a and between the walls 12b and 13b. The compression chambers C1 and C2 with a maximum volume are formed in positions opposed to each other across the center of the scroll compression mechanism. At this point, the bypass holes 46a and 46b do not communicate with the compression chambers C1 and C2.

In a step in which the revolving scroll 13 revolves π/2(rad) from the state of FIG. 5 to reach a state shown in FIG. 6, the compression chambers C1 and C2 move to the center. In the state shown in FIG. 6, the bypass holes 46a and 46b communicate with the compression chambers C1 and C2. Consequently, although volumes of the compression chambers C1 and C2 are gradually reduced, compression is not performed.

In a step in which the revolving scroll 13 revolves π(rad) from the state of FIG. 6 to reach a state shown in FIG. 7, the compression chambers C1 and C2 move to the center. In this step, since the bypass holes 46a and 46b do not communicate with the compression chambers C1 and C2, although a volume of the compression chambers C1 and C2 are gradually reduced, compression is not performed. In addition, in the state shown in FIG. 7, a portion in the outer end of the wall 12b is spaced apart from the surface of the wall 13b that faces opposite to the center of the spiral, and a portion in the outer end of the wall 13b is spaced apart from the surface of the wall 12b that faces opposite to the center of the spiral. In this case, leakage of fluid from the step portions 42 and 43 is assumed. However, since the bypass holes 46a and 46b communicate with the compression chambers C1 and C2 as described above, compression is not performed in the compression chambers C1 and C2. Thus, there is no influence of the leakage of fluid.

In a step in which the revolving scroll 13 revolves π/2(rad) from the state of FIG. 7 to reach a state shown in FIG. 8, the compression chambers C1 and C2 move to the center. In this step, since the bypass holes 46a and 46b communicate with the compression chambers C1 and C2, although a volume of the compression chambers C1 and C2 are gradually reduced, compression is not performed. In the state shown in FIG. 8, the opening of the bypass holes 46a and 46b are blocked by the edge 13c of the wall 13b. Consequently, the compression chambers C1 and C2 are brought into a closed state.

In a step in which the revolving scroll 13 revolves π(rad) from the state of FIG. 8 to reach a state shown in FIG. 9, the compression chambers C1 and C2 move to the center while keeping the closed state and a volume of the compression chambers C1 and C2 are gradually reduced to compress fluid. Thereafter, by continuing the compression, the compression chambers C1 and C2 merge to have a minimum volume, and fluid is discharged from the scroll compressor via the discharge port 25. Note that, in steps after FIG. 8, since the compression chambers C1 and C2 are in positions not involved in the step portions 42 and 43, the fluid in the compression chambers C1 and C2 never leak from the step portions 42 and 43.

Therefore, the scroll compressor according to the first embodiment includes the structure in which the step portions 42 and 43 and the bypass holes 46a and 46b are provided, and the bypass holes 46a and 46b are provided in the positions that is closer to the center of the spiral than the positions of the step portions 42 and 43. Consequently, when leakage of the fluid is assumed from a contact part of the step portions 42 and 43 and the stepped portions 44 and 45, since the bypass holes 46a and 46b communicate with the compression chambers C1 and C2 and compression is not performed, there is no influence of the leakage of the fluid. In addition, when the opening of the bypass holes 46a and 46b are blocked to bring the compression chambers C1 and C2 into the closed state, since the compression chambers C1 and C2 are in positions not involved in the step portions 42 and 43, the fluid in the compression chambers C1 and C2 never leaks from the step portions 42 and 43, and compression can be performed.

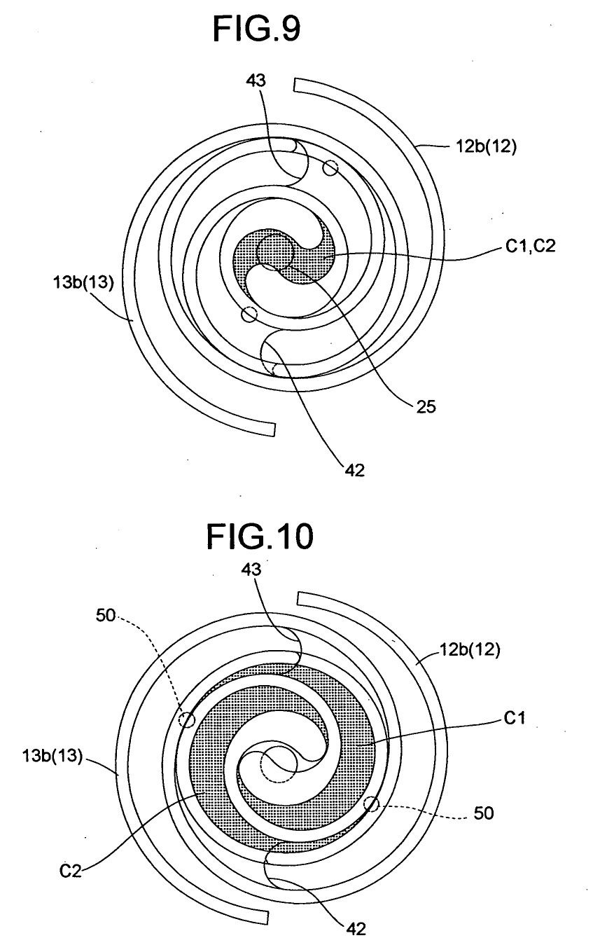

When bypass holes 50 are provided further on the outer end side of the spiral than the step portions 42 and 43 as shown in FIG. 10, even if opening of the bypass holes 50 are blocked and in a state of compression, a state occurs in which the step portions 42 and 43 are placed astride the compression chambers C1 and C2 that should perform compression. As a result, when volume control is performed in the bypass holes 50, a compression loss occurs because there is compression leakage in the step portions 42 and 43. On the other hand, the scroll compressor in the first embodiment can obtain the advantages of the step portions 42 and 43 and the bypass holes 46a and 46b without causing the compression loss.

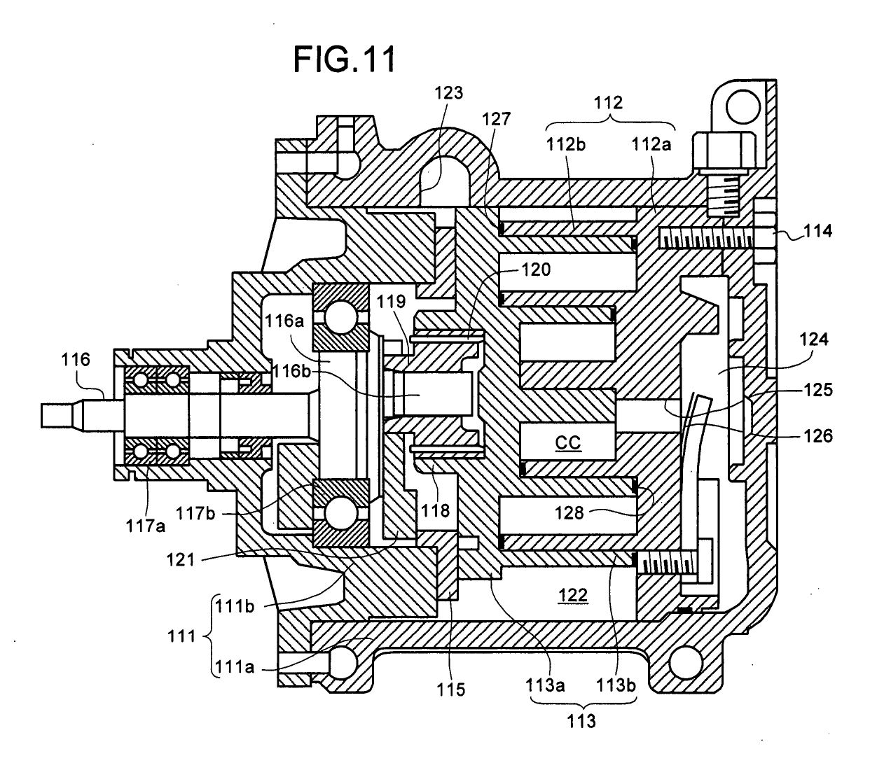

FIG. 11 is a sectional view of a scroll compressor in a second embodiment according to the present invention. This scroll compressor is provided with a scroll compression mechanism consisting of a fixed scroll 112 serving as a first scroll and a revolving scroll 113 serving as a second scroll in the inside of a housing 111.

The housing 111 includes a housing body 111a that is formed in a cup shape, which has an opening, and a lid plate 111b that is fixed to the housing body 111a at the opening.

The fixed scroll 112 includes vertically provided with a spiral wall 112b on a surface of an end plate 112a. The spiral wall 12a is arranged vertically to the end plate 112a. The revolving scroll 113 has substantially a same structure as the fixed scroll 112, and includes a spiral wall 113b on a surface of an end plate 113a. The wall 112b and the wall 113b are formed in substantially an identical shape.

The fixed scroll 112 is fastened to a bottom inside the cup shape of the housing body 111a with a bolt 114. The revolving scroll 113 is eccentric by a revolution radius and phase-shifted by 180 degrees with respect to the fixed scroll 112, and is combined with the fixed scroll 112 with the wall 113b thereof engaged with the wall 112b of the fixed scroll 112. Further, the revolving scroll 113 is supported to be capable of revolving, but not to be capable of rotating. A rotation preventing mechanism 115 that is provided between the lid plate 111b and the end plate 113a prevents the revolving scroll 113 from rotating.

Concerning the revolution of the revolving scroll 113, a rotation shaft 116 with a crank 116a is pierced through the lid plate 111b. This rotation shaft 116 is rotatably supported on the lid plate 111b via bearings 117a and 117b. A boss 118 is protrudingly provided in the center of the end plate 113a on a surface that is on an opposite side to the surface on which the wall 113b is arranged. An eccentric portion 116b of the crank 116a is rotatably housed in the boss 118 via a bearing 119 and a drive bush 120. Consequently, the revolving scroll 113 revolves according to the rotation of the rotation shaft 116. A balance weight 121, which cancels an unbalance amount given to the revolving scroll 113, is attached to the rotation shaft 116.

An intake chamber 122 is formed in a position around the fixed scroll 112 inside the housing body 111a. With respect to this intake chamber 122, an intake port 123, which guides low-pressure fluid toward the intake chamber 122, is provided in the housing body 111a. A discharge cavity 124 is arranged inside the housing body 111a. The discharge cavity 124 is sectioned by an inner surface of the housing body 111a and a surface of the end plate 112a that is on the opposite side to the surface on which the wall 112 b is arranged. With respect to this discharge cavity 124, a discharge port 125, which guides high-pressure fluid toward the discharge cavity 124, is arrange at the center of the end plate 112a on the surface on which the fixed scroll 112 is arranged. This discharge port 125 is provided in communication with a compression chamber CC, which moves to the center of the spirals of the walls 112b and 113b while gradually reducing a volume thereof, in the scroll compression mechanism consisting of the fixed scroll 112 and the revolving scroll 113. A discharge valve 126, which opens the discharge port 125 only when a predetermined or higher pressure acts thereon, is provided in the center of the end plate 12a on the surface that sections the discharge cavity 124.

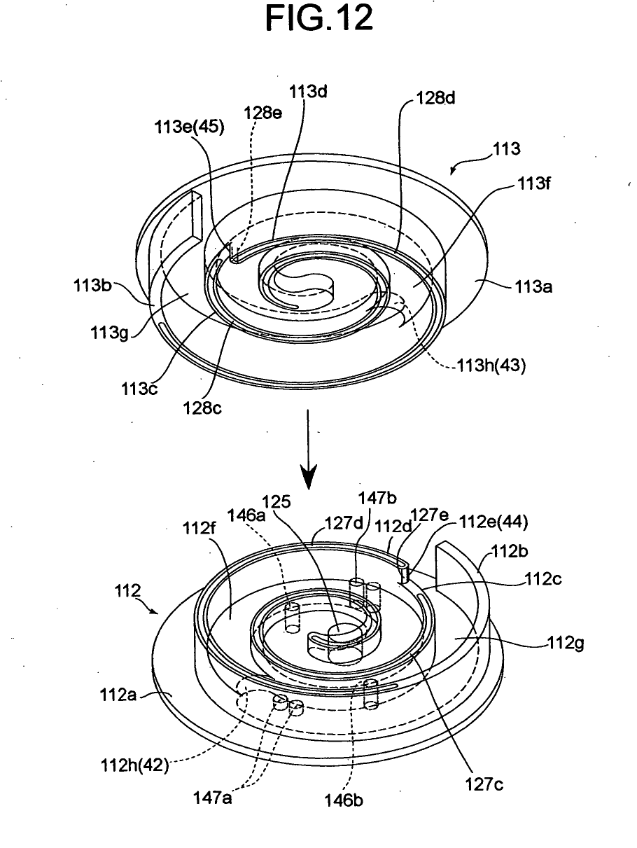

As shown in FIG. 12, the end plate 112a of the fixed scroll 112 includes a step portion 142. At this step portion 142, the surface of the end plate 112a that is toward the center of the spiral, which is formed by the wall 112b, is elevated than the surface of the end plate 112a that is toward the outer end of the spiral. Similarly, the end plate 113a of the revolving scroll 113 includes a step portion 143. At this step portion 143, the surface of the end plate 113a that is toward the center of the spiral, which is formed by the wall 113b, is elevated than the surface of the end plate 13a that is toward the outer end of the spiral. The step portions 142 and 143 are provided at positions that are substantially equidistance from the centers of the respective spirals.

Since the step portion 142 is formed on the surface of the end plate 112a, the flow path formed in the wall 112b can be divided into two portions, that is, a flow path having a shallower bottom surface 112f, which is closer to the center of the spiral, and a flow path having a deep bottom surface 112g, which is closer to the outer end of the spiral. A coupling wall surface 112h, which is formed in the step portion 142 and stands vertically to the adjacent bottom surfaces 112f and 112g, is present between the bottom surfaces 112f and 112g. Similarly, since the step portion 143 is formed on the surface of the end plate 113a, a spiral flow path formed in the wall 113b is divided into two portions, that is, a shallow bottom surface 113f provided closer to the center and a deep bottom surface 113g provided closer to the outer end. A coupling wall surface 113h, which forms the step portion 143 and stands vertically connecting the adjacent bottom surfaces 13f ad 113g, is present between the bottom surfaces 113f and 113g.

In addition, the wall 112b of the fixed scroll 112 includes a stepped portion 144 that corresponds to the step portion 143 of the revolving scroll 113. The wall 112b includes two portions of which edge is arranged at each different level. The edge of the portion that is closer to the center of the spiral is at a lower level than the edge of the portion that is closer to f the outer end of the spiral relative to the level of the surface of the end plate 112a. Similarly, the wall 113b on the revolving scroll 113 includes a stepped portion 145 that corresponds to the step portion 142 of the fixed scroll 112. The wall 13b includes two portions of which edge is arranged at each different level. The edge of the portion that is closer to the center of the spiral is at a lower level than the edge of the portion that is closer to the outer end of the spiral relative to the level of the surface of the end plate 113a.

Since the stepped portion 144 is formed, the edge of the wall 112b is divided into two portions, that is, a low edge 112c provided closer to the center and a high edge 112d provided closer to the outer end. A coupling edge 112e, which forms the stepped portion 144 and connects the edges 112c and 112d to be vertical to a revolving surface, is present between the adjacent edges 112c and 112d. Similarly, since the stepped portion 145 is formed, the edge of the wall 113b is divided into two portions, that is, a low edge 113c provided closer to the center and a high edge 113d provided closer to the outer end. A coupling edge 113e, which forms the stepped portion 145 and connects the edges 113c and 113d to be vertical to the revolving surface, is present between the adjacent edges 113c and 113d.

The coupling edge 112e is formed in such a manner that a surface of the coupling edge 112e that is vertical to the end plate 12a continues smoothly curving between the wall 112b. A curved line formed with the surface is semicircle when viewed from a direction perpendicular to the end plate 112a. Similarly, the coupling edge 113e is formed in such a manner that a surface of the coupling edge 113e that is vertical to the end plate 113a continues smoothly curving between the wall 113b. A curved line formed with the surface is semicircle when viewed from a direction perpendicular to the end plate 113a. In addition, the coupling wall surface 112h forms an arc that is identical with an envelope drawn by the coupling edge 113e in accordance with revolution of the revolving scroll 113 when the end plate 112a is viewed from a revolving shaft direction. Similarly, the coupling wall surface 113h forms an arc that is identical with an envelope drawn by the coupling edge 112e in accordance with revolution of the revolving scroll 113.

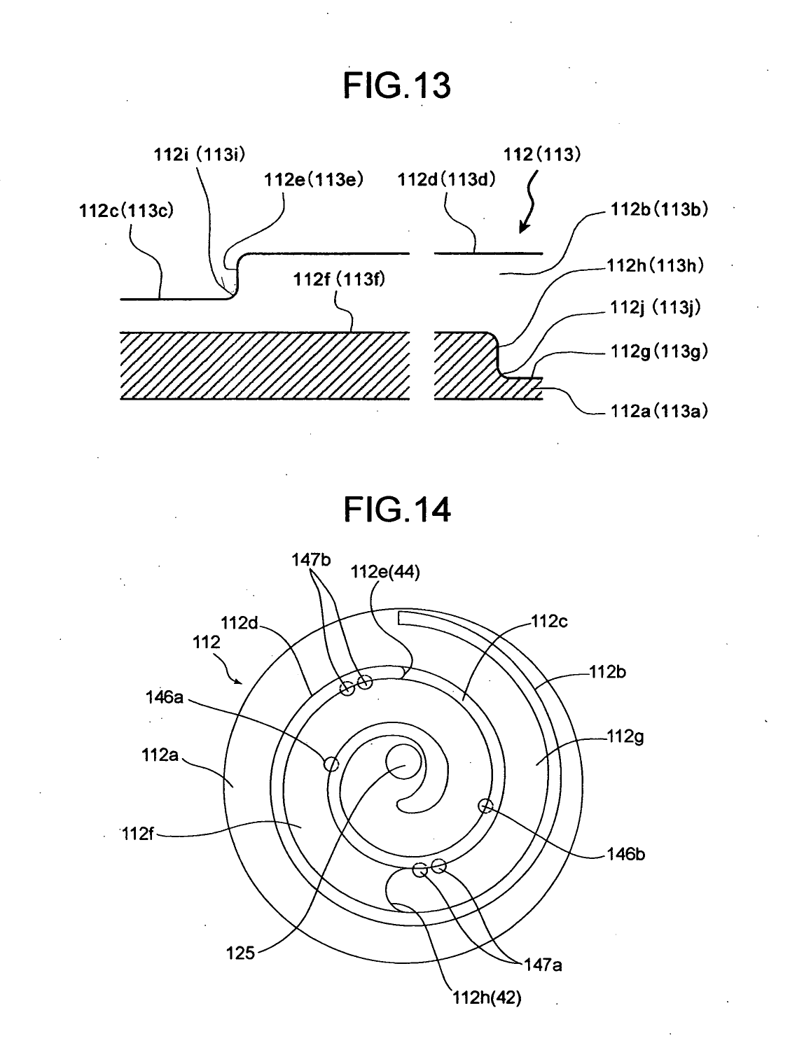

As shown in FIG. 13, a rib 112i is provided in a part where the edge 112c and the coupling edge 112e meet in the wall 112b as if the rib 112i is built up. The rib 112i is formed integrally with the wall 112b forming a recessed curved surface that continues smoothly to the edge 112d and the coupling edge 112e to avoid concentration of stresses. For the same reason, a rib 113i that has a same shape as the rib 112i is provided in a part where the edge 113c and the coupling edge 113e meet in the wall 113b.

A rib 112j is provided in a part where the bottom surface 112g and the coupling wall surface 112h meet in the end plate 112a as if the rib 112j is built up. The rib 112j is formed integrally with the wall 112b forming a recessed curved surface that continues smoothly to the bottom surface 112g and the coupling wall surface 112h to avoid concentration of stresses. Due to the same reason, a rib 113j of the same shape is provided in a part where the bottom surface 113g and the coupling wall surface 113h meet in the end plate 113a.

A part where the edges 112d and 112e meet in the wall 112b is chamfered to avoid interference with the rib 113j at the time of assembling. A part where the edges 113d and 113e meet in the wall 113b is chamfered to avoid interference with the rib 112j at the time of assembling.

As shown in FIG. 12, chip seals 127c, 127d, and 127e are disposed in the edges 112c and 112d and the coupling edge 112e of the wall 112b, respectively. Similarly, chip seals 128c, 128d, and 128e are disposed in the edges 113c and 113d and the coupling edge 113e of the wall 113, respectively.

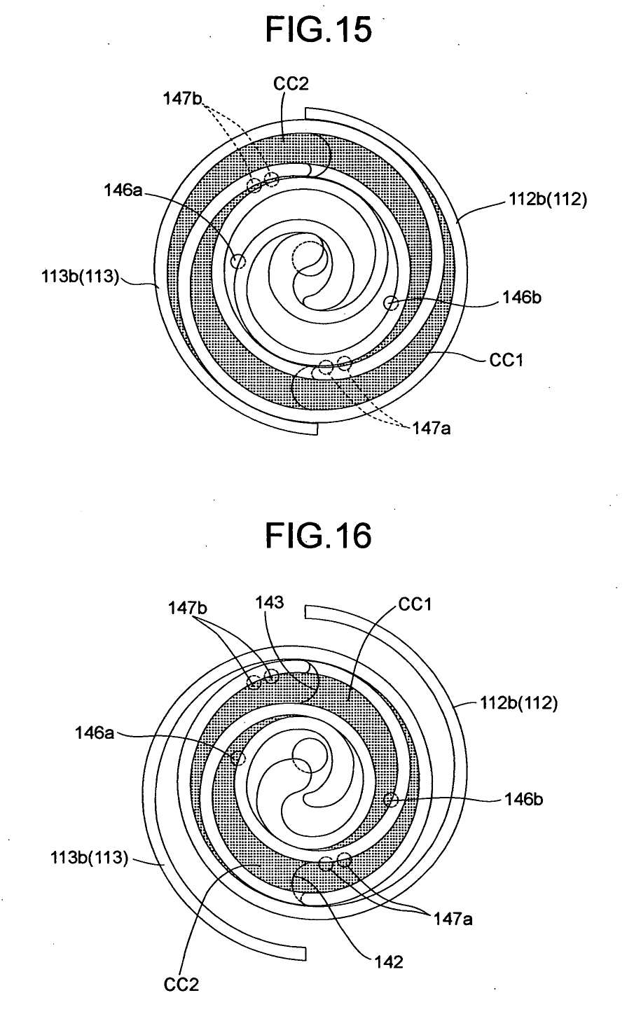

On the other hand, as shown in FIGS. 12 and 14, first bypass holes 146a and 146b that pair off with each other are provided on a bottom surface 112f. The bottom surface 112f is a surface of a portion in the end plate 112a of the fixed scroll 112 that is positioned closer to the center of the spiral than the position of the step portion 142. In addition, the first bypass holes 146a and 146b are provided in positions within 360 degrees (2π(rad)) to the center from positions of second bypass holes 147a and 147b, which will be described later, in a state in which the revolving scroll 113 is combined with the fixed scroll 112. The first bypass hole 146a is arranged on the bottom surface 112f at a position near the outer end of the spiral, and is arranged along the surface of the wall 112b that faces opposite to the center of the spiral. The first bypass hole 146b is in a symmetrical position with respect to the first bypass hole 146a and is arranged on the bottom surface 112f in a position near the center of the spiral, and is arranged along the surface of the wall 112b that faces toward the center of the spiral.

In a state in which the revolving scroll 113 is combined with the fixed scroll 112, openings of the first bypass holes 146a and 146b facing the end plate 112a are made openable and closable by the low edge 113c of the wall 113b of the revolving scroll 113. In addition, the first bypass holes 146a and 146b are pierced through the end plate 112a and open at the surface opposite to the surface on which the wall 112b is arranged. Although not clearly shown in the figures, opening of the first bypass holes 146a and 146b communicate with the intake chamber 122. For example, a part of the housing body 11a, where the opening of the first bypass holes 146a and 146b are located, is divided from the discharge cavity 124 by a partition wall or the like and communicates with the intake chamber 122. In addition, although not clearly shown in the figures, valves are provided in the opening of the first bypass holes 146a and 146b. The valves open and close the opening as required.

Second bypass holes 147a and 147b that pair off with each other are provided on the bottom surfaces 112g. The bottom surface 112g is a surface of a portion in the end plate 112a of the fixed scroll 112 that is positioned closer to the outer end of the spiral than the positions of the first bypass holes 146a and 146b. The second bypass holes 147a and 147b are provided in positions within 360 degrees (2π(rad)) to the center from the outer end of the spiral in a state in which the revolving scroll 113 is combined with the fixed scroll 112. The second bypass hole 147a is arranged on the bottom surface 112g at a position near the outer end of the spiral, and is arranged along the surface of the wall 112b that faces opposite to the center of the spiral. The second bypass hole 147b is in a symmetrical position with respect to the second bypass hole 147a and is arranged on the bottom surface 112f in a position near the center of the spiral, and is along the surface of the wall 112b that faces toward the center of the spiral. Note that the second bypass holes 147a and 147b in this embodiment are provided in parallel in two places, respectively.

In a state in which the revolving scroll 113 is combined with the fixed scroll 112, an opening of the second bypass hole 147a facing the end plate 112a is made openable and closable by the high edge 113d of the wall 113b of the revolving scroll 113. In addition, in a state in which the revolving scroll 113 is combined with the fixed scroll 112, an opening of the second bypass hole 147b that faces to the surface on which the wall 112b is arranged made openable and closable by the low edge 113c of the wall 113b of the revolving scroll 113. The second bypass holes 147a and 147b are pierced through the end plate 112a and open at the surface opposite to the surface on which the wall 112b is arranged. Although not clearly shown in the figures, opening of the second bypass holes 147a and 147b communicate with the intake chamber 122. For example, a part of the housing body 111a, where the opening of the second bypass holes 147a and 147b are located, is divided from the discharge cavity 124 by a partition wall or the like and communicates with the intake chamber 122. In addition, although not clearly shown in the figures, valves are provided in the opening of the second bypass holes 147a and 147b. The valves open and close the opening of the second bypass holes 147a and 147b as required.

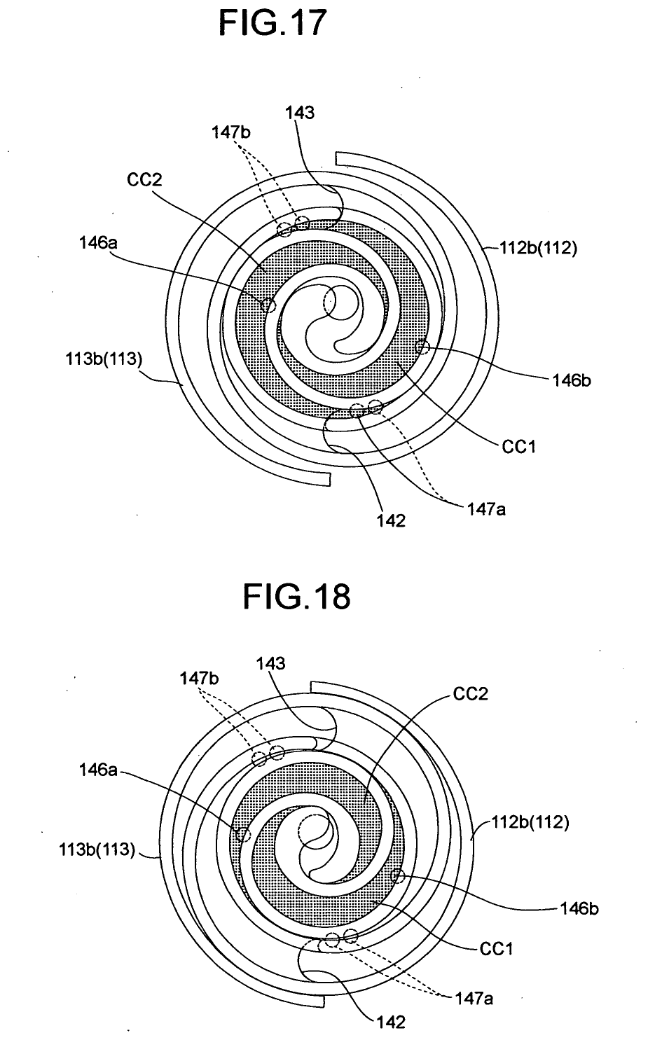

As shown in FIG. 15, when the revolving scroll 113 is combined with the fixed scroll 112, the low edge 113d comes into abutment against the shallow bottom surface 112f, and the high edge 13c comes into abutment against the deep bottom surface 112g. At the same time, the low edge 112d comes into abutment against the shallow bottom surface 113f, and the high edge 112c comes into abutment against the deep bottom surface 113g. Consequently, a pair of compression chambers CC1 and CC2, which are sectioned by the end plates 112a and 113a and the walls 112b and 113b opposed to each other, respectively, are formed between both the scrolls. In these compression chambers CC1 and CC2, since the deep bottom surfaces 112g and 113g face each other on the side closer to the outer end of the spiral than the step portions 142 and 143, the wide compression chambers CC1 and CC2 are obtained further on the outer end side of the spiral than the step portions 142 and 143. Since the shallow bottom surfaces 112g and 113g face each other on the side closer to the center of the spiral than the step portions 142 and 143, the narrow compression chambers CC1 and CC2 are obtained on side closer to the center of the spiral than the step portions 142 and 143. As a result, compression with a volume gradually reduced from the compression chambers CC1 and CC2 formed wide to the compression chambers CC1 and CC2 formed narrow is performed in the middle of movement of the compression chambers CC1 and CC2 from the outer end to the center in accordance with revolution of the revolving scroll 113. Thus, a compression ratio can be improved.

In the middle of movement of the compression chambers CC1 and CC2 from the outer end to the center in accordance with the revolution of the revolving scroll 113, when the edge 113c of the wall 113b comes off the opening of each of the bypass holes 46a and 46b facing toward the end plate 113a, and the valve in the opening is opened, the first bypass holes 146a and 146b and the second bypass holes 147a and 147b cause the compression chambers CC1 and CC2 and the intake chamber 122 to communicate with each other. In addition, the first bypass holes 146a and 146b separate the compression chambers CC1 and CC2 and the intake chamber 122 when the valves are closed. As a result, if the valves are opened as required, since compression is not performed in the compression chambers CC1 and CC2 of which compression is released through the opening of the first bypass holes 146a and 146b. The second bypass holes 147a and 147b are open, it becomes possible to reduce a compression volume to reduce load on the drive source driving the rotation shaft 116. In this way, the first bypass holes 146a and 146b and the second bypass holes 147a and 147b perform volume control for the compression chambers CC1 and CC2.

How the scroll compressor the compresses fluid will be explained with reference to FIGS. 15 to 20. Note that, in the following explanation, the valves are performing an opening operation in the opening the first bypass holes 146a and 146b and the second bypass holes 147a and 147b.

In the state shown in FIG. 15, an outermost end of the wall 112b comes into abutment against the surface of the wall 113b 13b that faces opposite to the center of the spiral, and an outermost end of the wall 113b comes into abutment against the surface of the wall 112b that face opposite to the center of the spiral. Fluid is encapsulated between the end plates 112a and 113a and between the walls 112b and 113b. The compression chambers CC1 and CC2 with a maximum volume are formed in positions opposed to each other across the center of the scroll compression mechanism. At this point, the second bypass holes 147a and 147b communicate with the compression chambers CC1 and CC2, and the first bypass holes 146a and 146b do not communicate with the compression chambers CC1 and CC2.

In a step in which the revolving scroll 113 revolves π(rad) from the state of FIG. 15 to reach a state shown in FIG. 16, the compression chambers CC1 and CC2 move to the center. In the state shown in FIG. 16, the first bypass holes 146a and 146b and the second bypass holes 147a and 147b communicate with the compression chambers CC1 and CC2. Consequently, although a volume of the compression chambers CC1 and CC2 are gradually reduced, compression is not performed.

In a step in which the revolving scroll 113 revolves π/2(rad) from the state of FIG. 16 to reach a state shown in FIG. 17, the compression chambers CC1 and CC2 moves to the center. In the state shown in FIG. 17, the first bypass holes 146a and 146b and the second bypass holes 147a and 147b communicate with the compression chambers CC1 and CC2. Consequently, although a volume of the compression chamber CC1 and CC2 are gradually reduced, compression is not performed. In addition, in the state shown in FIG. 17, the outer end of the wall 112b is spaced apart from the surface of the wall 113b that faces opposite to the center of the spiral, and a portion in the outer end of the wall 113b is spaced apart from the surface of the wall 112b that faces opposite to the center of the spiral. In this case, leakage of fluid from the step portions 142 and 143 is assumed. However, since the first bypass holes 146a and 146b and the second bypass holes 147a and 147b communicate with the compression chambers CC1 and CC2 as described above, compression is not performed in the compression chambers CC1 and CC2. Thus, there is no influence of the leakage of fluid.

In a step in which the revolving scroll 113 revolves π/2(rad) from the state of FIG. 17 to reach a state shown in FIG. 18, the compression chambers CC1 and CC2 moves to the center. In this step, since the bypass holes 146a and 146b communicate with the compression chambers CC1 and CC2, although a volume of the compression chambers CC1 and CC2 are gradually reduced, compression is not performed. In the state shown in FIG. 18, the opening parts of the second bypass holes 147a and 147b are blocked by the edge 113c of the wall 113b.

In a step in which the revolving scroll 113 revolves π/2(rad) from the state of FIG. 18 to reach a state shown in FIG. 19, the compression chambers CC1 and CC2 move to the center. In the state shown in FIG. 19, the opening parts of the first bypass holes 146a and 146b are blocked by the edge 113c of the wall 113b. Consequently, the compression chambers CC1 and CC2 are brought into a closed state.

In a step in which the revolving scroll 113 revolves π(rad) from the state of FIG. 19 to reach a state shown in FIG. 20, the compression chambers CC1 and CC2 move to the center while keeping the closed state and a volume of the compression chambers CC1 and CC2 are gradually reduced to compress fluid. Thereafter, by continuing the compression, the compression chambers CC1 and CC2 merge to have a minimum volume, and the fluid is discharged from the scroll compressor via the discharge port 125. Note that, in steps after FIG. 18, since the compression chambers CC1 and CC2 are in positions not involved in the step portions 142 and 143, the fluid in the compression chambers CC1 and CC2 never leak from the step portions 142 and 143.

Therefore, the scroll compressor according to the second embodiment includes the structure in which the step portions 142 and 143 and the first bypass holes 146a and 146b are provided, and the first bypass holes 146a and 146b are provided in the positions that is closer to the center of the spiral than the positions of the step portions 142 and 143. Consequently, when leakage of the fluid is assumed from a contact part of the step portions 142 and 143 and the stepped portions 144 and 145, since the bypass holes 146a and 146b communicate with the compression chambers CC1 and CC2 and compression is not performed, there is no influence of the leakage of the fluid. In addition, when the opening of the first bypass holes 146a and 146b are blocked to bring the compression chambers CC1 and CC2 into a closed state, since the compression chambers CC1 and CC2 are in positions not involved in the step portions 142 and 143, the fluid in the compression chambers CC1 and CC2 never leaks from the step portions 142 and 143, and compression can be performed.

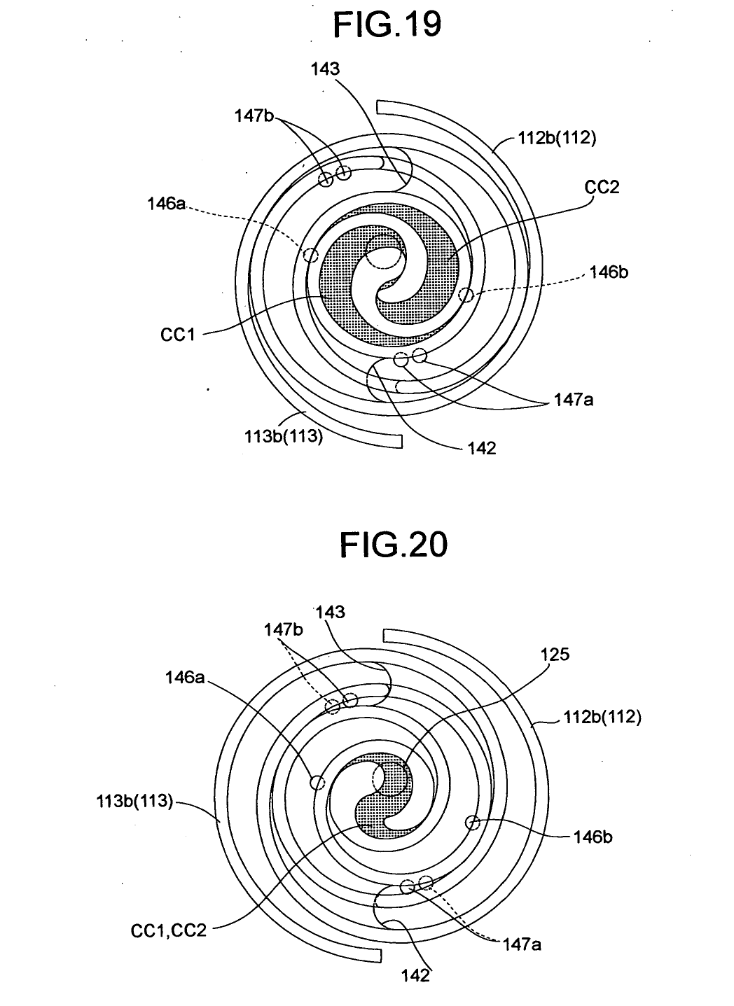

When bypass holes 150, which are equivalent to the first bypass holes 146a and 146b, are provided further on the outer end side of the spiral than the step portions 142 and 143 as shown in FIG. 21, even if opening of the bypass holes 50 are blocked and in a state of compression, a state occurs in which the step portions 142 and 143 are placed astride the compression chambers CC1 and CC2 that should perform compression. As a result, a compression loss occurs because there is compression leakage in the step portions 142 and 143 despite the fact that a compression volume of the bypass holes 150 is reduced. On the other hand, the scroll compressor in the first embodiment can obtain the advantages of the step portions 142 and 143 and the first bypass holes 146a and 146b without causing the compression loss.

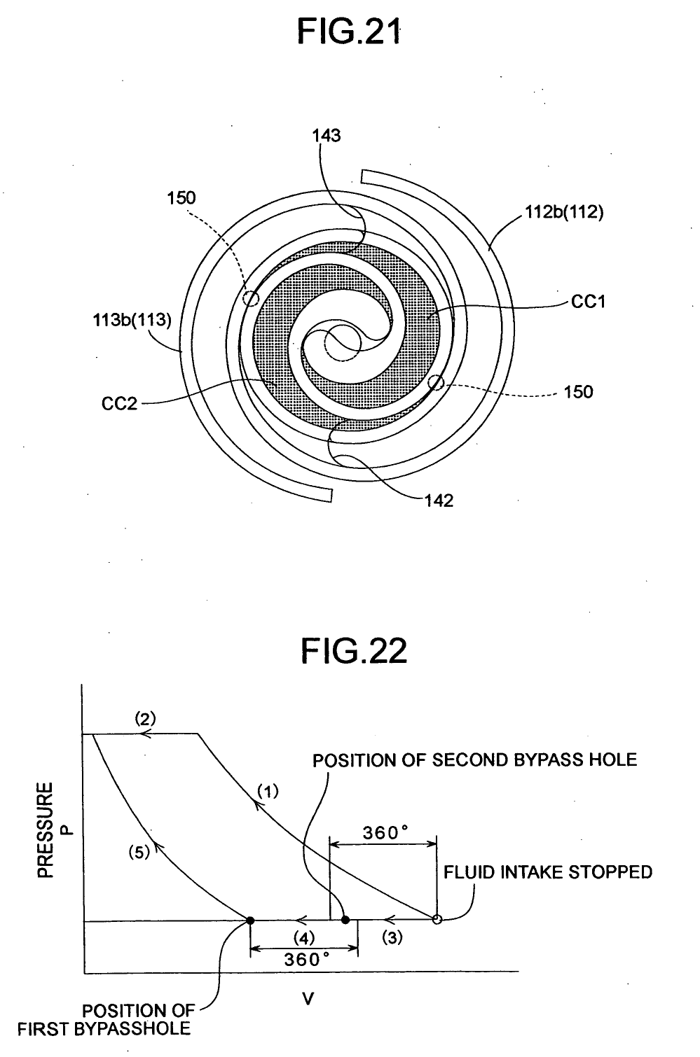

In the scroll compressor in the second embodiment, the second bypass holes 147a and 147b are provided in positions closer to the outer end of the spiral than the positions of the first bypass holes 146a and 146b and within 360 degrees (2π(rad)) to the center from the outer end of the spiral. In addition, the first bypass holes 146a and 146b are provided in positions within 360 degrees (2π(rad)) to the center from the positions of the second bypass holes 147a and 147b. Consequently, as shown in FIG. 22, volume control is applied to the compression chambers CC1 and CC2, which move according to revolution of the revolving scroll 113, with only the second bypass holes 147a and 147b present in the compression chambers CC1 and CC2 formed on the outermost end by closing up intake of the fluid (3). Volume control is applied to the compression chambers CC1 and CC2, which have moved to the center of the spiral from there, with both the first bypass holes 146a and 146b and the second bypass holes 147a and 147b present (3) (4). Then, the volume control is applied to the compression chambers CC1 and CC2, which have moved further to the center side of the spiral, with only the first bypass holes 146a and 146b present (4). This makes it possible to prevent excessive compression after the compression chambers CC1 and CC2 are formed on the side near the outermost end of the spiral before volume control is performed by the first bypass holes 146a and 146b. Note that, in FIG. 22, (1)→(2) indicates a case in which the valves of the first bypass holes 146a and 146b and the second bypass holes 147a and 147b are closed, and the volume control is not performed.

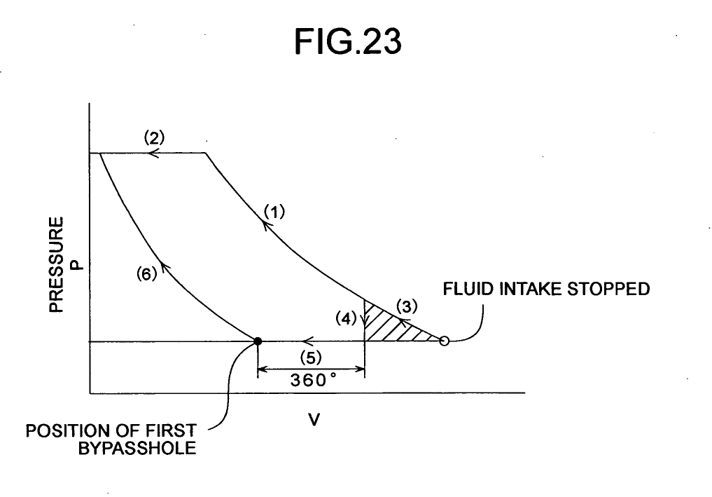

As shown in FIG. 23, when the second bypass holes 147a and 147b are not provided as shown in FIG. 23, after the excessive compression occurs (3)→(4), the volume control is performed by the first bypass holes 146a and 146b (5). In this way, the compression of the compression chambers CC1 and CC2 occurs 360 degrees or more before performing the volume control with the first bypass holes 146a and 146b. On the other hand, the scroll compressor in the second embodiment can obtain advantages of the step portions 142 and 143 and the first bypass holes 146a and 146b without causing the excess compression. Note that, in FIG. 23, (3)>(1) indicates a case in which the valves of the first bypass holes 146a and 146b are closed, and the volume control is not performed.

As described above, the scroll compressor according to the present invention makes it possible to reduce a compression loss. In particular, the scroll compressor is suitable for eliminating compression leakage in the step portions when volume control is performed by the bypass holes. In addition, in particular, the scroll compressor is suitable for preventing excessive compression.

Moreover, the bypass holes are provided in positions closer to the center of the spiral than positions of the step portions. Consequently, when leakage of fluid from the step portions is assumed, since compression is not performed through the bypass holes, there is no influence of the leakage of fluid. In addition, when the bypass holes are closed to bring the compression chambers into a closed state, since the compression chambers are in a positional relation in which the compression chambers are not involved in the step portions, compression in the compression chambers is performed without regard to the leakage of fluid from the step portions. As a result, advantages of the step portions and the bypass holes can be obtained without causing a compression loss due to the leakage of fluid from the step portions.

Moreover, the second bypass holes are provided in positions closer to the outer end of the spiral than positions of the first bypass holes and within 360 degrees to the center from the outer end of the spiral, and the first bypass holes are provided in positions closer to the center of the spiral than positions of the step portions and within 360 degrees to the center from the positions of the second bypass holes. Consequently, the second bypass holes can prevent excessive compression after the compression chambers are formed on a side near the outermost end of the spiral and before volume control is performed by the first bypass holes. In addition, since the first bypass holes are provided in the positions closer to the center of the spiral than the positions of the step portions, advantages of the step portions and the first bypass holes can be obtained without causing a compression loss due to leakage of fluid from the step portions.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A scroll compressor comprising:
a first scroll that has a first end plate and a first spiral wall disposed on a surface of the first end plate; and
a second scroll that has a second end plate and a second spiral wall on a surface of the second end plate, the second scroll being supported so as to be revolvable while being prevented from rotating, and the second spiral wall being engaged with the first spiral wall, wherein
at least one of the first end plate and the second end plate includes a step portion where a height of the surface of at least one of the first end plate and the second end plate is set high on a center side and is set low on an outer end side of a spiral along at least one of the first spiral wall and the second spiral wall,
at least one of the second spiral wall and the first spiral wall includes a stepped portion where a height of at least one of the second spiral wall and the first spiral wall is set low on the center side and is set high on the outer end side, so that the stepped portion engages the step portion so that a bottom surface of at least one of the first and the second scroll and an edge of at least one of the second spiral wall and the first spiral wall are in contact with each other to form a compression chamber surrounded by the first spiral wall, the second spiral wall, the first end plate and the second end plate,
the first end plate includes a first bypass hole that is provided in a position between the step portion and a center of the spiral, the first bypass hole communicates the compression chamber with outside thereof, and
the first end plate includes a second bypass hole that is provided in a position between the first bypass hole and an outer end of the spiral, the second bypass hole communicates the compression chamber with outside thereof.

2. The scroll compressor according to claim 1, wherein
the second bypass hole is provided at a position within 360 degrees from the outer end of the spiral to the center of the spiral, and the first bypass hole is provided at a position within 360 degrees from the second bypass hole to the center of the spiral.
